(19) United States
(12) Patent Application Publication
(10) Pub. No.: US 2013/0036198 A1
(43) Pub. Date: Feb. 7, 2013

(54) METHOD FOR IMPROVING THE OPERATION OF MACHINES OR APPLIANCES

(71) Applicants: UWE GALM, OFTERSHEIM (DE); MANFRED MIESSL, WEINHEIM (DE); TOM OELSNER, ERZHAUSEN (DE)

(72) Inventors: UWE GALM, OFTERSHEIM (DE); MANFRED MIESSL, WEINHEIM (DE); TOM OELSNER, ERZHAUSEN (DE)

(73) Assignee: HEIDELBERGER DRUCKMASCHINEN AG, HEIDELBERG (DE)

(21) Appl. No.: 13/567,343

(22) Filed: Aug. 6, 2012

(30) Foreign Application Priority Data
Aug. 4, 2011 (DE) 10 2011 109 388.9

(51) Int. Cl. G06F 15/16

(52) U.S. Cl. 709/217

(57) ABSTRACT

A method for improving the operation of machines or appliances having an associated machine computer and being connected to at least one further computer over a communication network, includes transmitting operating data and/or order data from the machine computer to the further computer through the communication network and storing the operating data and/or order data in the further computer. The further computer compares the performance of at least one machine with the performance of further machines, and the further computer calculates improved settings for at least one of the machines on the basis of the performance comparison and provides the settings for the purpose of setting the machine.

### CROSS-REFERENCE TO RELATED APPLICATION

This application claims the priority, under 35 U.S.C. §119, of German Patent Application DE 10 2011 109 388.9, filed Aug. 4, 2011; the prior application is herewith incorporated by reference in its entirety.

### BACKGROUND OF THE INVENTION

### Field of the Invention

The present invention relates to a method for improving the operation of machines or appliances having an associated machine computer and being connected to at least one further computer over a communication network.

It is customary today for many machines, such as machine tools or printing machines, to be connected to a computer through an Internet connection for the purpose of remote maintenance. In that way, problems occurring on the machines can be rectified easily and quickly by changing certain settings over the Internet, without the need for service personnel to be deployed in situ. That ensures rapid maintenance and is also significantly less expensive than if service personnel were to have to be deployed in situ. The communication infrastructure used for the remote maintenance, in the form of computers with an Internet connection, can also be used for further purposes, however. Thus, German Patent Application DE 10 2010 019 063, corresponding to U.S. Patent Application Publication No. US 2011/0270651, discloses a system for analyzing production processes for printing machines in which the production performance of a machine is compared with the production performance of other machines. In that case too, the machines have associated computers which are connected through a network to a central computer which compares the performances of the machines. The performance comparison computer then calculates the production times of comparable machines on the basis of the data delivered by the machine computers and sends the result of the performance comparison to the respective machine computer. In that way, the operator of a machine can tell how it compares with other comparable machine operations. In a second step, the operator of the machine can furthermore obtain improvement proposals from the performance comparison computer, which allows the operator to make the operating procedure more efficient. To that end, the operator has suitable products and services from the manufacturer transmitted to the operator on request through the performance comparison computer, with those products and services being able to be confirmed by the operator as appropriate. However, that practice has the disadvantage that the operator of the machine merely has proposals transmitted thereto, but the settings of the existing machines are not specifically optimized.

German Patent DE 10 2008 015 222 B4, corresponding to U.S. Patent Application Publication No. US 2008/0234869, discloses a method for monitoring an air-conditioning system in a building. In that case too, the air-conditioning systems in the building have a connection to a computer which monitors and evaluates the data from the air-conditioning systems. Using the evaluated data, the computer is used to calculate optimized characteristic curves for controlling the air-conditioning systems in the building and then to send the characteristic curves to the air-conditioning systems in order to optimize the settings for the air-conditioning systems in the building. However, a disadvantage of that method is that the computer calculates characteristic curves merely by taking into account the air-conditioning systems in one building and thus does not benefit from the settings for the air-conditioning systems in other comparable buildings.

Secure remote control for remote maintenance is disclosed in U.S. Pat. No. 7,328,347 B2. U.S. Pat. No. 7,287,473 B2 discloses capturing operating states for printing machines.

### SUMMARY OF THE INVENTION

It is accordingly an object of the invention to provide a method for improving the operation of machines or appliances having an associated machine computer, which overcomes the hereinafore-mentioned disadvantages of the heretofore-known methods of this general type and which allows the calculation of improved settings for the machines and does so by taking the broadest possible basis from similar machines.

With the foregoing and other objects in view there is provided, in accordance with the invention, a method for improving the operation of machines or appliances having an associated machine computer and being connected to at least one further computer over a communication network. The method comprises transmitting operating data and/or order data from the machine computer to the further computer over the communication network and storing the operating data and/or order data in the further computer, comparing a performance of at least one machine with a performance of further machines in the further computer, and calculating improved settings for at least one of the machines, in the further computer, on a basis of the performance comparison and providing the improved settings for setting the machine.

According to the present invention, the machines or appliances for which operation is intended to be improved have an associated machine computer. This machine computer is connected to at least one further computer over a communication network, such as the Internet. This further computer may likewise be associated with a machine, or it may be a central computer for the manufacturer or service provider. The invention is particularly suitable for improving printing machines, folding machines and other machines in the graphics industry.

A common feature of the central and local methods is that machines need to be explicitly identifiable and are able to communicate with other machines. This is accomplished by using the known methods and techniques of Internet-based remote maintenance service, in which machines are managed in explicitly identified form at a service center or through the use of a management computer. Identification is usually effected by using an explicit machine number or else digital certificates. In order to participate in methods according to the invention, the machine is enabled by the machine user/service engineer. It then transmits its identity with further communication parameters to the central computer and is thus initially registered. Prior to use of the method according to the invention, the machine registers with the service center, which is the sole communication partner in the case of the central method. In the case of local methods, the central computer undertakes only the task of a management computer and forwards only the information about the contactability of further communication partners and, if appropriate, also conveys the connection to these further participants.

In the case of the refinement with a central computer, the central computer receives operating data and print order data from a printing machine and also associated characteristic curves, which are transmitted to it by every participating machine computer at the end of an order at stipulated times, e.g. once a day, or at the request of the central computer. In this case, the operating data and print order data from the machine computer are transmitted to the further central computer over the Internet and are stored in the further central computer. The further computer then compares the performances of at least one machine with the performance of further machines and thus establishes whether or not improved settings, e.g. in the form of characteristic curves, are possible for the machine associated with the machine computer. If this is the case, the further computer calculates these improved characteristic curves and stores them centrally.

In a second method step, prior to the execution of a print order, the machine computer uses the order data and local settings to ask the central further computer whether or not optimized characteristic curves/settings are available. The central further computer transmits these back to the machine computer, which transfers these settings either automatically or following manual approval by the machine user. In this way, it is possible for the settings of many machines to be taken into account for optimizing the setting of another machine, and thus for one machine to be able to benefit from the settings of many other machines.

In one refinement of the invention, it is also possible for the central computer to transmit all optimized characteristic curves/settings to the machine computers at stipulated times. However, the large volume of data and currentness of the data mean that the variant of inquiring prior to the start of the print order is preferred.

Besides the central calculation and evaluation through a server with the manufacturer or service provider, there is particular interest in an alternative refinement of the invention, according to which the further computer is likewise associated with a machine. In this case, all machine computers involved store their operating data and associated order data/settings locally as empirical knowledge. Prior to the start of a print order, an inquiring computer sends the order data and operating data with the machine settings. Every computer of every machine receives the data from the inquiring machines, insofar as they are technically contactable, and evaluates them itself in a manner suitable for the machine associated with the respective machine computer.

In one preferred variant embodiment, the inquirer asks only those other machine computers from which it expects to gain empirical knowledge, e.g. only computers which are associated with the format class of the associated printing machine. In the case of the local variant, the second machine computer can simply receive the data and establish whether or not it has already had such a print order with the associated settings itself, and can return this information to the inquiring computer. In this case, every machine computer stores its own complete order data with the empirical knowledge from the settings and performances when executing the print order. The inquiry can also be answered without storing the inquiry data by simply returning suitable empirical knowledge. Whether this empirical knowledge is actually better than the local settings or is the best of all empirical knowledge is evaluated by the inquiring computer itself in the case of the local approach, since the calculation and decision are intended, according to the invention, to be undertaken by the inquiring computer, and the distributed machine computers merely contribute their empirical knowledge. Since the inquiring machine computer undertakes the evaluation and calculation, the data do not need to be returned to the machine again, but rather can be used as operating data directly in the machine computer which is associated with the relevant machine. First and foremost, this refinement of the invention has the great advantage that there is no need for central data storage of all order and operating data, and the operating data also do not need to be transmitted as empirical knowledge for the purpose of central storage. However, a disadvantage of this embodiment is that active machine computers can communicate their empirical knowledge only at the time of the inquiry and that the machine computers themselves need to have a sufficiently large memory to be able to store all local empirical knowledge. However, this disadvantage can be offset by virtue of the machine computers additionally storing their data on so-called cloud computers on the Internet, with the cloud computers always being online, which means that the data on the cloud computers can always be accessed by inquiring machine computers, even if machine computers to which inquiries are being sent are themselves offline.

In one refinement of the invention, the computers of the machines are identified and only computers which have themselves released data for data interchange are able to receive and evaluate data from other computers. This refinement of the invention makes sense both for the central method and for the local method. First of all, the machines need to be explicitly identifiable on the communication network, so that appropriate data can be sent to and associated with them. Furthermore, the operator of the machine must approve the operating data from the operator's own machine being transmitted to the other computers. Should the operator of the machine deny this data interchange, it cannot participate in the method according to the invention and is not provided with improved settings. This ensures that only those operators of machines which are themselves likewise prepared to contribute to improving the setting of all machines benefit from improved setting data from other machines.

In a further refinement of the invention, the optimized characteristic curves or settings are displayed on a display of the computer of the machine and the transfer of the optimized characteristic curves or settings can be accepted or declined by operating an operator control element of the computer of the machine. The operator of the machine is thus provided with the opportunity to first of all check the improvement to the characteristic curves or settings which has been ascertained for it. It is only when the operator of the machine is satisfied with the improved setting values that the operator is able to use a mouse, keyboard or other operating control element, such as a touchscreen, on the computer of the machine to confirm the transfer of the improved characteristic curves and to transfer them for setting the operator's own machine. The operator of the machine is at all times the master of what improvements to the settings on the operator's machine are made, and the operator does not have to be prepared for settings on the machine to be altered without the operator's knowledge.

In a further refinement of the invention, prior to the use of the characteristic curves or settings from another machine for operation of the machine, the compatibility of the other machine with the machine is checked by a computer and the data are used only if there is sufficient compatibility. Particularly in the case of printing machines, there are many different customer-specific adjustments even for one machine type. Thus, the number of printing units and the number of peripheral devices are variable, and it is additionally possible for changes to be made which the customer requires. For this reason, it is not readily possible to transfer the settings of one machine type to the settings of the same machine type, since even one and the same machine type may be configured very differently. Prior to the transfer of the improved characteristic curves or settings, a check is therefore first of all performed to determine whether or not the improved characteristic curves or settings are also compatible with the actual configuration of the machine being used. If compatibility is possible by correcting the data by computer, e.g. for color settings from six colors to four colors, the data are first of all converted into a compatible form and are then also used. If, however, even conversion does not allow the improved settings to be compatible with the machine being used, the improved characteristic curves or settings are not used.

Advantageously, there is furthermore provision for the operating or order data from the machines to be categorized into different classes and for the computer of the machine to be able to be used to release individual classes for data interchange. Thus, the operator is first of all able to decide which data the operator wishes to release to other computers for data interchange and which data the operator also actually wishes to improve. In printing machines, there are four setting options, e.g. settings for the inking unit, dampening units, printing units, for the register, settings on the feeder, delivery, etc. The operator of the machine can then select which of these setting options the operator wishes to have optimized in the first place. If the operator wishes to optimize only the setting for the inking units, for example, then the operator selects this class and releases it for data interchange. However, in return, the operator then also receives only improved operating data for setting the inking units. In this case too, the assurance is again provided that an operator of a machine can benefit only from improved operating data which the operator is also prepared to provide for others. On the other hand, if the operator is merely interested in optimizing particular characteristic curves, the operator does not immediately have to provide all of the data for other machine operators, for example if the operator does not wish to do so for competitive reasons.

In one particularly advantageous refinement of the invention, the computers of the machine have a display apparatus, those computers of the machines which are registered on the communication network can be presented on the display and a selection option for involving desired computers of the machines in the data interchange can be selected for the purpose of transmitting operating data and/or order data. This type of refinement of the invention is suitable particularly for the local method, where the individual computers of the machines communicate with one another directly over the Internet. In this case, the operator of the machine can have a list of all computers participating in the method according to the invention displayed on a screen associated with the machine computer. Using a search function, the operator can also specifically input names of print shops or operators which are known to the operator and can display the machine computers thereof, insofar as they are registered on the communication network. These computers can be displayed on the screen in the form of icons, which in turn have associated properties of the machine and/or of the operator. The operator of the machine can then select the machines which are acceptable to the operator and can click on them using a mouse, for example, and involve them in the data interchange. This can be accomplished in a manner similar to social networks, such as Facebook, by virtue of the operator of the machine selecting a machine as a “friend” and thus involving that machine in the operator's network for the purpose of data interchange. In this way, the operators of the machines are able to organize themselves into various user groups in the communication network, with it naturally being possible for one and the same operator of a machine to belong to a plurality of user groups. In this way, it is possible to set up a social network for the interchange of operating data and/or order data for machines in order to optimize these machines.

In a further refinement of the invention, the communication network includes a multiplicity of computers which receive and store the operating data and/or order data from the computers of the machine, calculate improved characteristic curves or settings and return the settings to the respective computer of the machine in suitable fashion. Besides involving the machine computers concerned, it is thus possible to involve computers connected to the Internet for processing the operating and/or order data in the calculation of improved characteristic curves, as is the case with so-called “cloud computing”. This method has the great advantage that, even in the case of the local method, the calculation of improved characteristic curves and of the performance comparison, which requires quite a high level of computer power, does not have to be performed on the associated machine computer, which is possibly currently working to capacity with other calculations, but rather can take place on any computers connected to the Internet which are currently not working to full capacity. Thus, a machine computer may have a respective associated cloud computer which is always connected to the Internet and can also participate in the data interchange when the associated machine computer is switched off or offline. The operating data and/or order data and the improved characteristic curves are also stored not only on the machine computer itself in this case, but rather can likewise be stored in the “computer cloud,” which means that it is also possible to save storage space on the machine computers.

Other features which are considered as characteristic for the invention are set forth in the appended claims.

Although the invention is illustrated and described herein as embodied in an automatic method for improving the operation of machines or appliances, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a network having a machine computer and a central computer for calculating improved characteristic curves for printing machines;

FIG. 2 is a perspective view of a network in which the improved characteristic curves are calculated locally in the machine computers; and

FIG. 3 is a perspective view of a network with cloud computers.

### DETAILED DESCRIPTION OF THE INVENTION

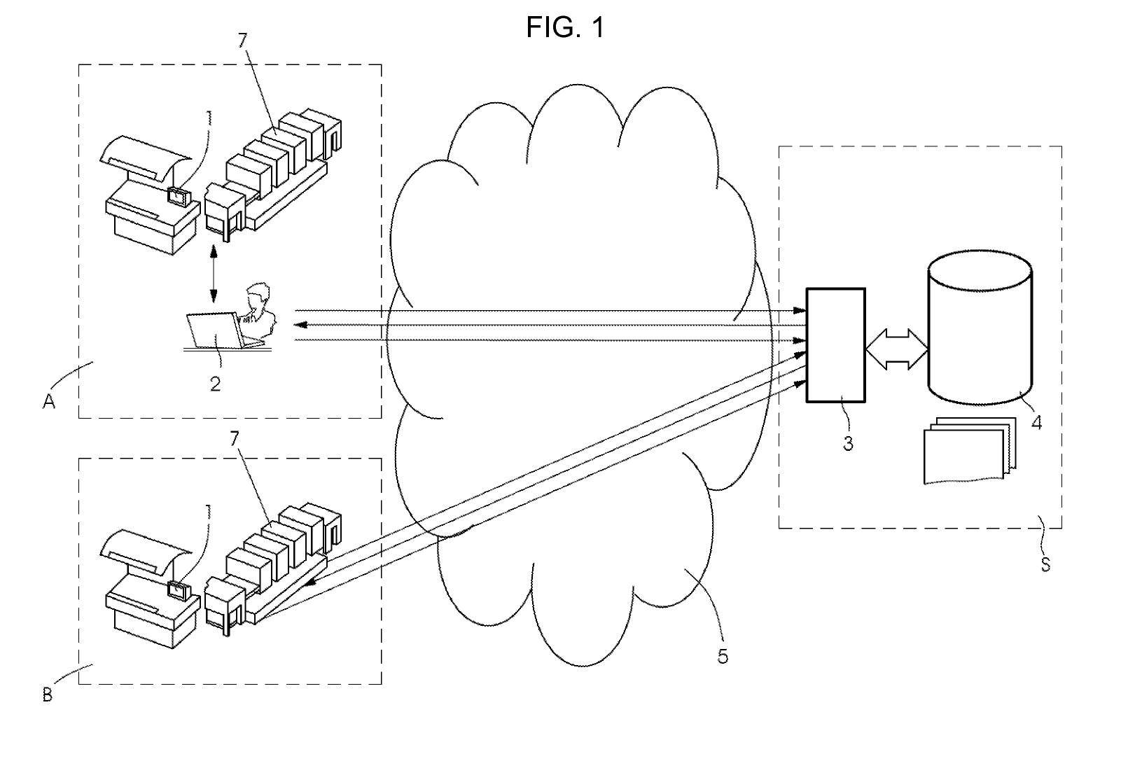

Referring now to the figures of the drawings in detail and first, particularly, to FIG. 1 thereof, there is seen an embodiment of the invention which works with a central management computer 3 for a service provider S. There are fundamentally two processes, firstly an inquiry with order data prior to a printing operation and secondly transmission of empirical data from an executed print order to a control center. By way of example, FIG. 1 depicts two print shops A, B each having a printing machine 7 with an associated printing machine computer 1. The print shop A furthermore also has a print room server 2 which communicates with the printing machine computer 1 and the printing machine 7. In this case, the print room server 2 is connected through a network connection to the Internet 5, which is in turn connected to the management computer 3 for the service provider S. The management computer 3 receives all operating and/or order data sent by the printing machine computers 1 and the print room server 2 and stores them in a database 4. To this end, before the start of a new print order, the printing machine computer 1 or the print room server 2 sends all settings relating to performance for the respective printing machine 7 to the management computer 3 over the Internet 5. The management computer 3 receives these data and searches the database 4 for suitable stored machine profiles and for settings optimized for preceding print orders, particularly characteristic curves for actuating the respective printing machine 7. These new improved settings are returned by the management computer 3 to the printing machine computer 1 or the print room server 2 over the Internet 5. The thus improved settings can either be transferred automatically or can be confirmed by the user or head of the print shop on the printing machine computer 1 or print room server 2 by operating an operator control element on the computer 1, 2. When the improved setting data have been transferred, the new print order is performed using these improved setting data. When the print order has been completed, all data relating to performance and also the actually used settings are in turn returned to the central management computer 3 and stored in the database 4 as empirical knowledge. It is then a simple matter for that empirical knowledge just to be stored, and the settings are calculated at the next inquiry time, or the management computer 3 calculates improved settings immediately after the empirical knowledge has been transmitted. In this case, the data from all operating data stored in the database 4 for other printing machines 7 are always also evaluated at the same time, so that the operator of a printing machine 7 can benefit from the settings from other printing machines 7. The optimum settings are calculated on the basis of the compared settings from suitable printing machines 7 and print orders and are stored in the database 4.

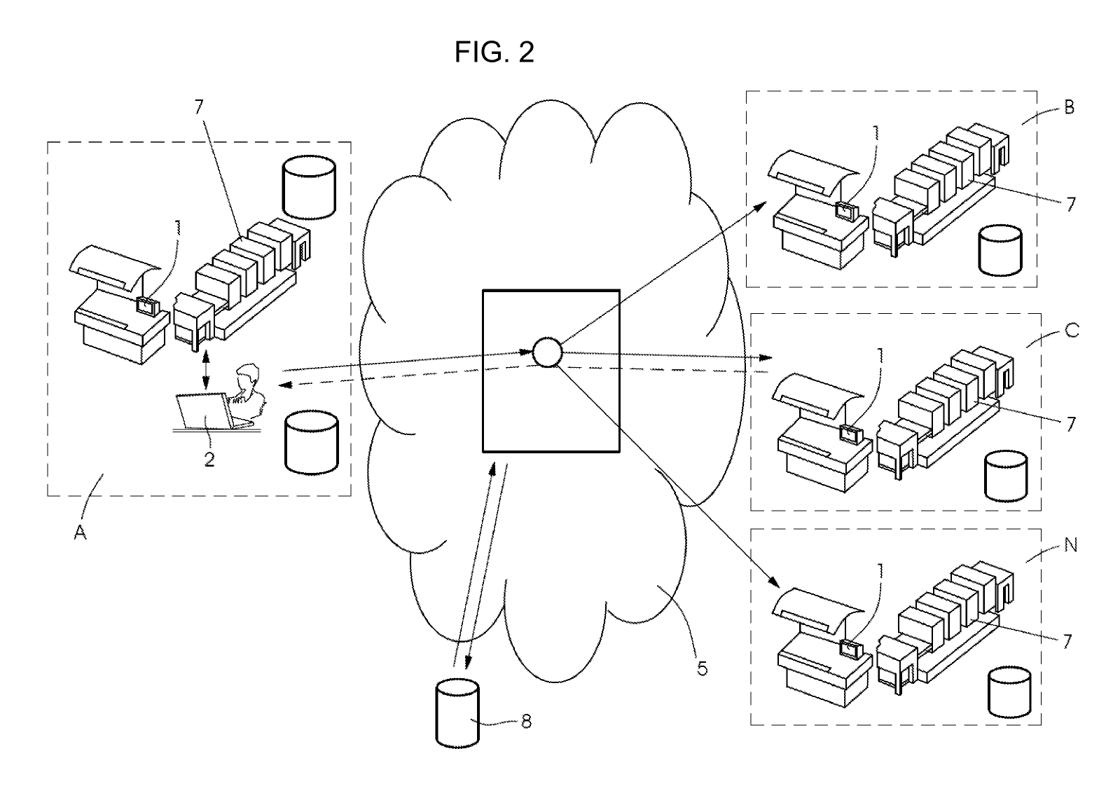

FIG. 2 shows a further refinement of the invention, in which the method according to the invention is organized locally. In the case of this refinement of the invention, it is possible for the participating machines 7 to interchange their knowledge directly, and the role of central data processing as in FIG. 1 is dispensed with, with no further empirical knowledge needing to be returned and stored centrally in this case. By way of example, FIG. 2 shows four print shops A, B, C, N each having a printing machine 7 and a printing machine computer 1. The print shop A additionally in turn contains a print room server 2. In this case too, all of the computers 1, 2 are connected to one another over the Internet 5. However, operating data from the respective machines 7 are no longer sent to a management computer 3 centrally, but rather are transmitted to the suitable machines 7 directly over the Internet 5. To this end, the machine computers 1 and the print room server 2 store the respective properties of the associated machine 7, so that only the printing machine computers 1 and the print room server 2 interchange operating data with one another for which the machines 7 suit one another. This prevents incompatible machines 7 from more readily impairing than improving the settings of other machines 7. In this case, the empirical data are stored locally on the computers 1, 2 of the machines 7 and the other computers 1, 2 respond only to the inquiry from a machine 7. Nothing is interchanged in advance.

The printing machines 7 are explicitly identified and registered for this method. The registration operation can be performed manually using an Internet portal or can take place automatically using the explicitly associated serial number of the printing machine 7, for example. The data interchange among the computers 1, 2 over the Internet 5 is controlled by a management computer 8, which routes the inquiries by a computer 1 to the relevant other computers 1, 2, but the management computer 8 does not receive any operating data or order data and also does not have to calculate any improved machine settings, which is accomplished exclusively on the computer 1, 2 of the inquiring printing machine 7. Only registered and identified print shops A, B, C, N are able to participate in the interchange of the operating data.

In the refinement shown in FIG. 2, a service provider S does not undertake the improvement and management of the operating data, but instead a platform managed by the management computer 8 is provided for the purpose of data interchange of operating data and order data between participating computers 1, 2. For this reason, the interchange of operating data in this case takes place in such a way that a machine sends an inquiry to all further computers 1, 2 which are connected to the Internet 5 and cleared. This inquiry contains particular data from the printing machine 7, the settings, particularly characteristic curves, of which need to be improved. All participating computers 1, 2 which are connected to suitable machines 7 over the Internet 5 then respond and provide appropriately compatible operating data in the response, which is in turn transmitted to the one computer 1, 2 over the Internet 5. The responses obtained in this manner are then used by the computer 1, 2 to optimize its own settings, such as the characteristic curves of the associated printing machine 7, and it also stores the improved operating data locally on the computer 1, 2. The computer 1, 2 itself responds in the same way to inquiries from other computers 1, 2 which are participating in the interchange of operating data over the Internet 5. The data interchange among the computers 1, 2 can be optimized when the participating computers 1, 2 know status information and configurations from the printing machine 7. In that case, inquiries are, from the outset, sent only to the participants from which usable empirical knowledge can be expected on the basis of machine similarity.

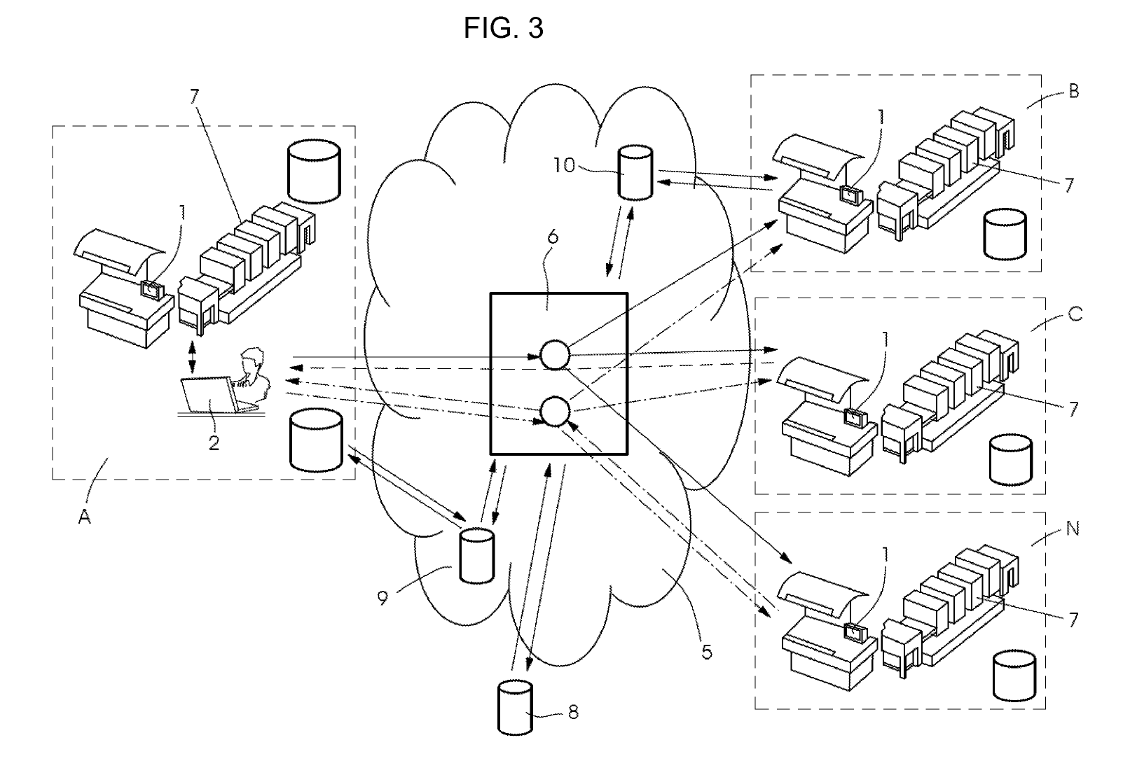

The embodiment in FIG. 3 is also organized locally, and in this case too a management computer 8 manages the data interchange. However, the variant in FIG. 3 differs from the variant in FIG. 2 in that the calculation of the improved settings or characteristic curves does not take place, or does not take place exclusively, in the respective computer 1, 2 of the associated printing machine 7, but rather other computers 9, 10 in the local network 5 are also used with computers 6 for calculating and managing improved operating data. By way of example, FIG. 3 shows so-called “cloud computers” 9, 10, which in reality may include a plurality of computers on the Internet 5 which are associated with a computer 1, 2. The computers 9, 10 are always connected to the Internet 5 in such a way that the data from the associated computers 1, 2 are always available for inquiries and it is also always possible for the computers 9, 10 to calculate improved characteristic curves for the printing machines, even if the computers 1, 2 in the print shop are switched off, for example at night, or undergoing maintenance. This means that no longer does just one computer 1, 2 calculate and manage the improved operating data, but rather other computers 9, 10 connected to the Internet 5 are also used. This also has the advantage that the computers 1, 2 in the print shop A are not so severely encumbered with the calculations of the improved operating data, and the computers 1, 2 thus continue to be available for other tasks in the print shop A.

1. A method for improving the operation of machines or appliances having an associated machine computer and being connected to at least one further computer over a communication network, the method comprising the following steps:
transmitting at least one of operating data or order data from the machine computer to the further computer over the communication network and storing the at least one of operating data or order data in the further computer;
comparing a performance of at least one machine with a performance of further machines in the further computer; and
calculating improved settings for at least one of the machines, in the further computer, on a basis of the performance comparison and providing the improved settings for setting the machine.

2. The method according to claim 1, which further comprises operating the further computer to:
receive the at least one of operating data or order data from the machine computers connected through the communication network,
evaluate the data centrally,
calculate the improved settings for each machine, and
return the settings to the respective machine computer in a manner suitable for the associated machine.

3. The method according to claim 1, which further comprises:
associating the further computer with a machine or an appliance;
interchanging at least one of operating data or order data between the further computer and the other machine computers through the communication network; and
performing a performance comparison on a basis of the at least one of operating data or order data from the other machines and calculating improved settings for the associated machine, in the further computer.

4. The method according to claim 1, which further comprises:
identifying the computers of the machines; and
only computers having themselves released data for data interchange are able to receive and evaluate data from other computers.

5. The method according to claim 1, which further comprises:
displaying the improved settings on a display of the computer of the machine; and
accepting or declining a transfer of the improved settings by operating an operator control element of the computer of the machine.

6. The method according to claim 1, which further comprises:
including characteristic curves for operation of the machine in the improved settings; and
transferring the characteristic curves for the operation of the machine, following confirmation, using an operator control element on the computer of the machine.

7. The method according to claim 1, which further comprises:
prior to using operating data from another machine for operation of the machine, checking compatibility of the other machine with the machine by one of the computers; and
using the data only if there is sufficient compatibility.

8. The method according to claim 1, which further comprises:
categorizing the operating or order data from the machines into different classes; and
using the computer of the machine to release individual classes for data interchange.

9. The method according to claim 1, which further comprises:
providing the computers of the machine with a display apparatus;
presenting on the display apparatus those computers of the machines registered on the communication network; and
selecting a selection option for involving desired computers of the machines in the data interchange for transmitting at least one of operating data or order data.

10. The method according to claim 1, which further comprises providing the communication network with a multiplicity of computers receiving and storing the at least one of operating data or order data from the computers of the machines, calculating improved settings and returning the settings to the respective computer of the machine in suitable fashion.
